(19) United States
(12) Patent Application Publication
(10) Pub. No.: US 2016/0284130 A1
(43) Pub. Date: Sep. 29, 2016

(54) DISPLAY CONTROL METHOD AND INFORMATION PROCESSING APPARATUS

(71) Applicant: FUJITSU LIMITED, Kawasaki-shi (JP)

(72) Inventor: SUSUMU KOGA, Kawasaki (JP)

(73) Assignee: Fujitsu Limited, Kawasaki-shi (JP)

(21) Appl. No.: 15/062,471

(22) Filed: Mar. 7, 2016

(30) Foreign Application Priority Data
Mar. 26, 2015 (JP) 2015-064262

(51) Int. Cl. G06T 19/00; G06T 7/00

(52) U.S. Cl. CPC G06T 19/006; G06T 7/004; G06T 2207/10004

(57) ABSTRACT

A display control method is executed by a computer. The display control method includes determining, when object data is detected, whether a present mode is a mode for receiving input of position information with which the object data is to be associated, the object data being registered in association with a position in an area that is specified according to a terminal position and an orientation of a terminal; and displaying, on a display unit, a distance information item indicating a distance from the terminal when the present mode is the mode for receiving the position information with which the object data is to be associated. The object data is displayed on the display unit by using the distance information item.

### CROSS-REFERENCE TO RELATED APPLICATION

This patent application is based upon and claims the benefit of priority of the prior Japanese Patent Application No. 2015-064262 filed on Mar. 26, 2015, the entire contents of which are incorporated herein by reference.

### FIELD

The embodiments discussed herein are related to a display control method and an information processing apparatus.

### BACKGROUND

The Augmented Reality (AR) technology is known, in which object data is displayed by being superimposed on part of an image captured by an imaging device such as a camera. In the AR technology, there is a process of setting the type and the display position (arrangement information) of the object data to be displayed on the screen (hereinafter, referred to as “authoring process” according to need). In the authoring process, when setting the display position of the object data, the position in the horizontal direction (x axis), the position in the depth direction (y axis), and the position in the vertical direction (z axis) are registered.

Furthermore, in the authoring process, coordinates (x, y, z) in the three-dimensional orthogonal coordinate system corresponding to position information (latitude, longitude, altitude) obtained from a Global Positioning System (GPS), etc., are managed as AR content information by being associated with the object data.

In the AR display after the above authoring process, the AR content information associated with position and the orientation of the terminal is acquired, and object data included in the acquired AR content information is displayed at a predetermined position on the screen based on the arrangement information.

Patent Document 1: International Publication No. 2012/127605

### SUMMARY

According to an aspect of the embodiments, a display control method is executed by a computer, the display control method including determining, when object data is detected, whether a present mode is a mode for receiving input of position information with which the object data is to be associated, the object data being registered in association with a position in an area that is specified according to a terminal position and an orientation of a terminal; and displaying, on a display unit, a distance information item indicating a distance from the terminal when the present mode is the mode for receiving the position information with which the object data is to be associated, wherein the object data is displayed on the display unit by using the distance information item.

According to an aspect of the embodiments, a non-transitory computer-readable recording medium stores a display control program that causes a computer to execute a process, the process including determining, when object data is detected, whether a present mode is a mode for receiving input of position information with which the object data is to be associated, the object data being registered in association with a position in an area that is specified according to a terminal position and an orientation of a terminal; and displaying, on a display unit, a distance information item indicating a distance from the terminal when the present mode is the mode for receiving the position information with which the object data is to be associated, wherein the object data is displayed on the display unit by using the distance information item.

According to an aspect of the embodiments, an information processing apparatus includes a processor configured to execute a process including determining, when object data is detected, whether a present mode is a mode for receiving input of position information with which the object data is to be associated, the object data being registered in association with a position in an area that is specified according to a position and an orientation that are detected; and displaying, on a display unit, a distance information item indicating a distance from the information processing apparatus when the present mode is the mode for receiving the position information with which the object data is to be associated, wherein the object data is displayed on the display unit by using the distance information item.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an example of a functional configuration of a terminal;

FIG. 2 illustrates an example of a hardware configuration of the terminal;

FIGS. 3A through 3D illustrate examples of various kinds of data applied in an embodiment;

FIG. 4 illustrates an example of a data configuration of various kinds of data;

FIG. 5 is a flowchart of an example of a display control process according to an embodiment;

FIG. 6 is a flowchart of an example of a guide display process;

FIGS. 7A and 7B illustrate a first example of displaying guides according an embodiment;

FIG. 8 illustrates an example of a screen of the radar map;

FIGS. 9A and 9B illustrate a second example of displaying guides according to an embodiment;

FIGS. 10A and 10B illustrate a third example of displaying guides according to an embodiment; and

FIGS. 11A and 11B illustrate a fourth example of displaying guides according to an embodiment.

### DESCRIPTION OF EMBODIMENTS

When editing the display position of the object data by using the three-dimensional position information obtained from GPS, etc., it has not been possible to accurately input the position of the depth direction (for example, the y axis direction in a coordinate system from GPS).

Preferred embodiments of the present invention will be explained with reference to accompanying drawings.

### <Example of Functional Configuration of Information Processing Apparatus>

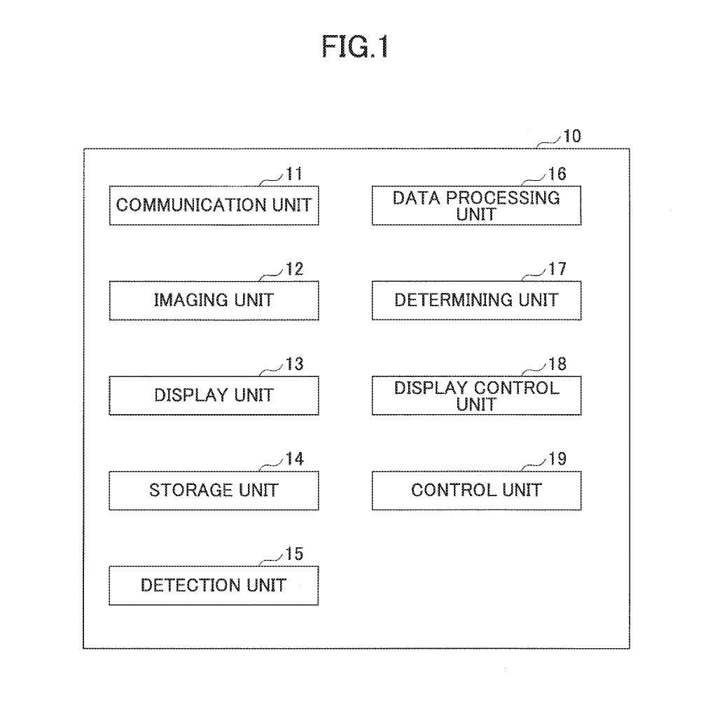

An example of a functional configuration of an information processing apparatus (hereinafter, referred to as a “terminal”, according to need) is described with reference to a figure. FIG. 1 illustrates an example of a functional configuration of a terminal. A terminal 10 illustrated in FIG. 1 includes a communication unit 11, an imaging unit 12 (image acquiring unit), a display unit 13, a storage unit 14, a detection unit 15, a data processing unit 16, a determining unit 17, a display control unit 18, and a control unit 19.

The communication unit 11 is connected to an external device, which is connected via a communication network such as the Internet, a Local Area Network (LAN), etc., in a state where the communication unit 11 is able to transmit and receive data with the external device. The communication unit 11 sends AR content information including, for example, the object data and the corresponding arrangement information that are registered in the data processing unit 16, to a management server, etc., via the communication network. Furthermore, the communication unit 11 receives AR content information, etc., registered in the management server, etc.

Furthermore, the communication unit 11 may perform short-range communication with a computer such as another terminal 10, etc., by using a communication method such as infrared communication, Wi-Fi (registered trademark), Bluetooth (registered trademark), etc.

The imaging unit 12 captures (photographs) images at fixed frame intervals, and generates image data. For example, the imaging unit 12 is a digital camera, etc.; however, the imaging unit 12 is not so limited. Furthermore, the imaging unit 12 built in the terminal 10, or may be an external device that may be connected to the terminal 10. When the imaging unit 12 is mounted, the orientation, such as the tilt and the direction, etc., of the imaging unit 12 is preferably operated integrally with the terminal 10; however, the imaging unit 12 is not so limited. Furthermore, the imaging unit 12 may acquire image data captured externally. In this case, the position information and orientation information are preferably included; however, the imaging unit 12 is not so limited.

The display unit 13 displays the captured image acquired from the imaging unit 12 on a screen, and displays a composite image in which object data is superimposed on the captured image. Furthermore, the display unit 13 displays a menu screen and a setting screen that are set in advance for performing a display control process according to the present embodiment, and an operation screen, etc., for operating the terminal 10. Furthermore, the display unit 13 may be used as a touch panel, etc., for inputting information from the screen.

The storage unit 14 stores various kinds of information needed for the present embodiment. For example, the storage unit 14 may write and read information, by the control of the control unit 19, etc. For example, the storage unit 14 stores AR content information (for example, an AR content table, a scenario management table and a scene management table for distinguishing the AR contents, etc.), a guide display table, various kinds of setting information other than the above, etc.; however, the stored contents are not so limited. Furthermore, the above kinds of information may be information acquired from a management server, etc., or information set by the user from the terminal 10.

The detection unit 15 acquires the position information and the orientation information of the terminal 10 or the imaging unit 12, for example, by using one or more positioning methods. The positioning method of the position information is, for example, GPS; however, the positioning method is not so limited. For example, the detection unit 15 may acquire position information (latitude, longitude, altitude) from the position of a Wi-Fi network (for example, a router), a mobile network (for example, a base station), etc., to which the terminal 10 is connected. For example, when the terminal 10 is connected to a plurality of Wi-Fi networks and mobile networks at the same time, the detection unit 15 may acquire the position information of the terminal 10 by using an average value of the respective position information items or the position information of a router or base station having the maximum reception intensity.

Furthermore, as the positioning method of the orientation information, for example, an electronic compass, a gyro sensor, etc., may be used to acquire the azimuth direction information (pitch, azimuth, roll), etc.; however, the positioning method is not so limited. The electronic compass is an example of a geomagnetic sensor, a azimuth sensor, etc., which acquires the azimuth direction information by detecting the earth magnetism in a two-dimensional or three-dimensional manner and determining which direction the terminal 10 or the imaging unit 12 is facing with respect to the earth magnetism. Furthermore, a gyro sensor may acquire the azimuth direction information by detecting that the terminal 10 or the imaging unit 12 is rotating or detecting that the orientation of the terminal 10 or the imaging unit 12 has changed.

The detection unit 15 periodically acquires the above-described position information and orientation information at predetermined timings. Furthermore, the detection unit 15 may acquire the detection distance and the imaging range (angular field information) obtained by various sensors, the imaging unit 12, etc., from setting information set in advance.

The data processing unit 16 performs data processing corresponding to a mode set in advance. For example, in the case of a mode of performing an authoring process, the data processing unit 16 registers the type, the size, the rotation angle, the display position, etc., of the object data, with respect to an area specified according to the position and the orientation of the terminal 10. At this time, the data processing unit 16 may set the display position of the object data, by using the position information obtained by the detection unit 15. Furthermore, the data processing unit 16 may set a display position based on information (guides) indicating the distance from the terminal 10 displayed on a screen by the display control unit 18.

The data processing unit 16 may store the registered information as AR content information in the storage unit 14, or may send this information to a management server or another terminal 10, etc., via the communication unit 11. Furthermore, the data processing unit 16 may acquire AR content information, a guide display table, etc., from a management server, etc., and store the acquired information in the storage unit 14.

Furthermore, for example, in the case of a viewing mode of displaying the AR content information, which has undergone authoring, on a screen, the data processing unit 16 refers to the AR content information registered in advance, based on a position in the area specified according to the position and the orientation of the terminal 10. Furthermore, when a corresponding AR content information item is detected, the data processing unit 16 causes the display unit 13 to display the object data included in the detected AR content information. Note that the types of modes are not limited to the above examples.

The determining unit 17 determines whether the mode at the data processing unit 16 is a mode for performing authoring (a mode for determining the position at which the object data is to be displayed). For example, when the mode for performing the authoring process has been set by a user's operation on a screen, etc., the determining unit 17 determines whether the mode is the mode for performing the authoring process or a viewing mode (a mode of displaying the AR content information that has already undergone authoring), according to the information set by the user's operation.

The display control unit 18 displays information (guides) indicating the distance from the terminal 10 on the screen of the display unit 13, when the determination result obtained by the determining unit 17 is a mode for performing an authoring process. Furthermore, the display control unit 18 may display guides up to a predetermined distance, at intervals set in advance by using the distance from the terminal 10 as a reference. There may be one or more types of guides, and when there are a plurality of types of guide, the user, etc., may set the type of guide. By displaying these guides, it is possible to support the user in inputting the position in the depth direction when the user inputs the position information of the object data, and in the case of the viewing mode, the object data is displayed at an appropriate position.

Furthermore, the display control unit 18 may display a radar map, in which the position information of AR content information around the terminal 10 is displayed as a map, on the screen. IN this case, the display control unit 18 may also display the position information of the guides in the radar map. Note that the type of the map is not limited to a radar map.

The control unit 19 controls all elements in the terminal 10. For example, the control unit 19 performs an authoring process according to the mode of the terminal 10 selected by the user, and performs a process of viewing the AR content information that has undergone the authoring process. Furthermore, the control unit 19 implements control of starting and ending the display control process according to the present embodiment, and implements control when an error occurs.

For example, the terminal 10 is a tablet terminal, a smartphone, a Personal Digital Assistant (PDA), a notebook PC, etc.; however, the terminal 10 is not so limited, for example, the terminal 10 may be a game console and a communication terminal such as a mobile phone.

Furthermore, as an example of the terminal 10, a transmission type display device, such as a head mounted display (HMD), an eyeglass type display, etc., may be used. A head mounted display and an eyeglass type display are wearable type devices having a transmission type screen (display unit) at a position corresponding to the user's eyes (within the eyesight). The terminal 10 may display the above-described object data and guides within the eyesight range that the user is actually viewing, by displaying the above-described object data and guides in a transmissive manner on a transmission type screen (display unit). Note that the object data and guides may be displayed as display objects having transmittivity, and may be subjected to display control by the display control unit 18.

Furthermore, in the case of a head mounted display, an eyeglass type display, etc., among the elements of the terminal 10 described above, the elements relevant to the display unit 13, etc., may be provided in a separate body from the other elements, and a configuration similar to the terminal 10 described above may be realized by connecting these elements in the separate body.

### <Example of Hardware Configuration of Terminal 10>

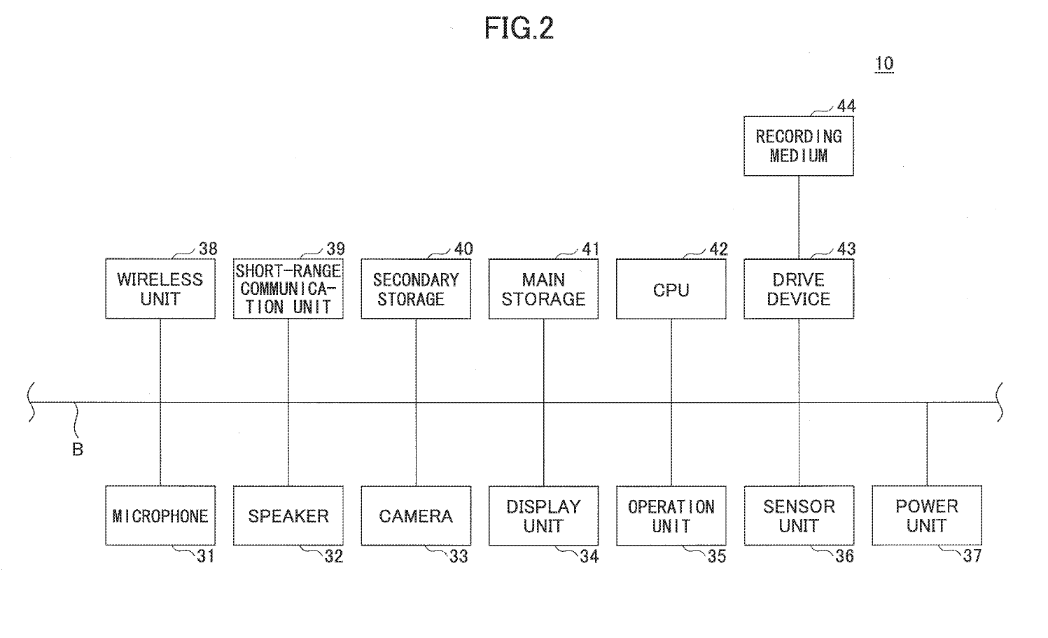

Next, an example of a hardware configuration of a computer functioning as the terminal 10 is described with reference to a figure. FIG. 2 illustrates an example of a hardware configuration of the terminal 10. In the example of FIG. 2, the terminal 10 includes a microphone 31, a speaker 32, a camera 33, a display unit 34, an operation unit 35, a sensor unit 36, a power unit 37, a wireless unit 38, a short-range communication unit 39, a secondary storage 40, a main storage 41, a Central Processing Unit (CPU) 42, and a drive device 43, which are connected to each other by a system bus B.

The microphone 31 inputs a voice sound emitted by the user and other sounds. The speaker 32 outputs the voice sound of a communication partner or outputs the sound of a ringtone, etc. For example, the microphone 31 and the speaker 32 may be used when speaking with a communication partner by a call function; however, the present embodiment is not so limited, the microphone 31 and the speaker 32 may be used for inputting and outputting information by voice sound.

The camera 33 captures an image (a video, a still image) of the real space within the field angle set in advance, for example. The camera 33 is an example of the imaging unit 12 described above. The camera 33 may be built in the terminal 10, or may be provided externally.

The display unit 34 displays, to the user, a screen (for example, an image in which the object data is superimposed on a real space, etc.) set by the Operating System (OS) and various applications. The display unit 34 is an example of the display unit 13 described above.

Furthermore, the display unit 34 may be a touch panel display, etc., in which case the display unit 34 also has a function of an input output unit. Furthermore, the display unit 34 may be a transmission type display. The display unit 34 is, for example, a display such as a Liquid Crystal Display (LCD), an organic Electro Luminescence (EL) display, etc.

The operation unit 35 includes operation buttons displayed on the screen of the display unit 34 and operation buttons, etc., provided on the outside of the terminal 10. The operation buttons may be, for example, a power button, a sound volume adjustment button, operation keys for inputting characters arranged in a predetermined order, etc. For example, as the user performs a predetermined operation on the screen of the display unit 34 or presses the above-described operation button, a touch position on the screen is detected by the display unit 34, and an application execution result, object data, an icon, a cursor, etc., is displayed on the screen.

The sensor unit 36 detects operations, etc., based on the position, the orientation, the acceleration, etc., of the terminal 10 at a certain time point or continuously; however, the sensor unit 36 is not so limited. The sensor unit 36 is an example of the detection unit 15 described above. The sensor unit 36 is, for example, GPS, a gyro sensor, a tilt sensor, an acceleration sensor, etc.; however, the sensor unit 36 is not so limited.

The power unit 37 supplies power to the elements of the terminal 10. The power unit 37 is, for example, an internal power source such as a battery; however, the power unit 37 is not so limited. The power unit 37 may detect the power level constantly or at predetermined time intervals, and monitor the remaining amount of energy, etc.

The wireless unit 38 is, for example, a transmission reception unit of communication data that receives wirelessly-transmitted signals (communication data) from a base station (mobile network) by using an antenna, etc., and sending wirelessly-transmitted signals to the base station via the antenna.

The short-range communication unit 39 is able to perform short-range communication with a computer such as another terminal 10, etc., by using a communication method such as infrared communication, Wi-Fi, Bluetooth, etc. The wireless unit 38 and the short-range communication unit 39 described above are communication interfaces that enable the transmission and reception of data with another computer.

The secondary storage 40 is a storage unit such as a Hard Disk Drive (HDD), a Solid State Drive (SSD), etc. The secondary storage 40 stores an execution program (display control program) according to the present embodiment, a control program provided in the computer, etc., and performs input and output according to need, based on control signals from the CPU 42. The secondary storage 40 may read and write information that is needed from various kinds of stored information, based on control signals, etc., from the CPU 42.

The main storage 41 stores execution programs, etc., read from the secondary storage 40 according to an instruction from the CPU 42, and stores various kinds of information, etc., obtained while executing a program. The main storage 41 is, for example, a Read-Only Memory (ROM), a Random Access Memory (RAM), etc.

The CPU 42 implements the processes in display control according to the present embodiment, by controlling the processes of the entire computer such as various calculations, input and output of data with respect to various hardware elements, etc., based on control programs such as the OS, etc., and execution programs stored in the main storage 41. The CPU 42 is an example of the control unit 19 described above.

Specifically, the CPU 42 executes programs installed in the secondary storage 40 based on, for example, an instruction to execute a program, etc., obtained from the operation unit 35, etc., to perform a process corresponding to the program in the main storage 41. For example, the CPU 42 executes the display control program to perform processes such as communication of various kinds of data by the communication unit 11, capturing images by the imaging unit 12, displaying various kinds of information by the display unit 13, displaying various kinds of information by the storage unit 14, detecting position information and orientation information by the detection unit 15, etc., as described above. Furthermore, the CPU 42 executes the display control program to perform processes such as registering AR content information in the authoring process by the data processing unit 16, viewing the AR content information, determining by the determining unit 17, implementing display control by the display control unit 18, etc., as described above. The process contents at the CPU 42 are not limited to the above contents. The contents executed by the CPU 42 are stored in the secondary storage 40, etc., according to need.

In the drive device 43, for example, a recording medium 44 may be set in a removable manner, and the drive device 43 may read various kinds of information recorded in the set recording medium 44 and write predetermined information in the recording medium 44. The drive device 43 is, for example, a medium loading slot, etc.; however, the drive device 43 is not so limited.

The recording medium 44 is a computer-readable recording medium that stores execution programs, etc., described above. The recording medium 44 may be, for example, a semiconductor memory such as a flash memory, etc. Furthermore, the recording medium 44 may be a portable recording medium such as a Universal Serial Bus (USB) memory, etc.; however, the recording medium 44 is not so limited.

In the present embodiment, by installing execution programs (for example, a display control program, etc.) in the hardware configuration of the computer main unit described above, the hardware resources and the software cooperate with each other to implement the display control process, etc., according to the present embodiment. Furthermore, for example, the display control program corresponding to the display control process described above may be resident in the terminal 10, and may be activated according to an activation instruction.

### <Example of Data>

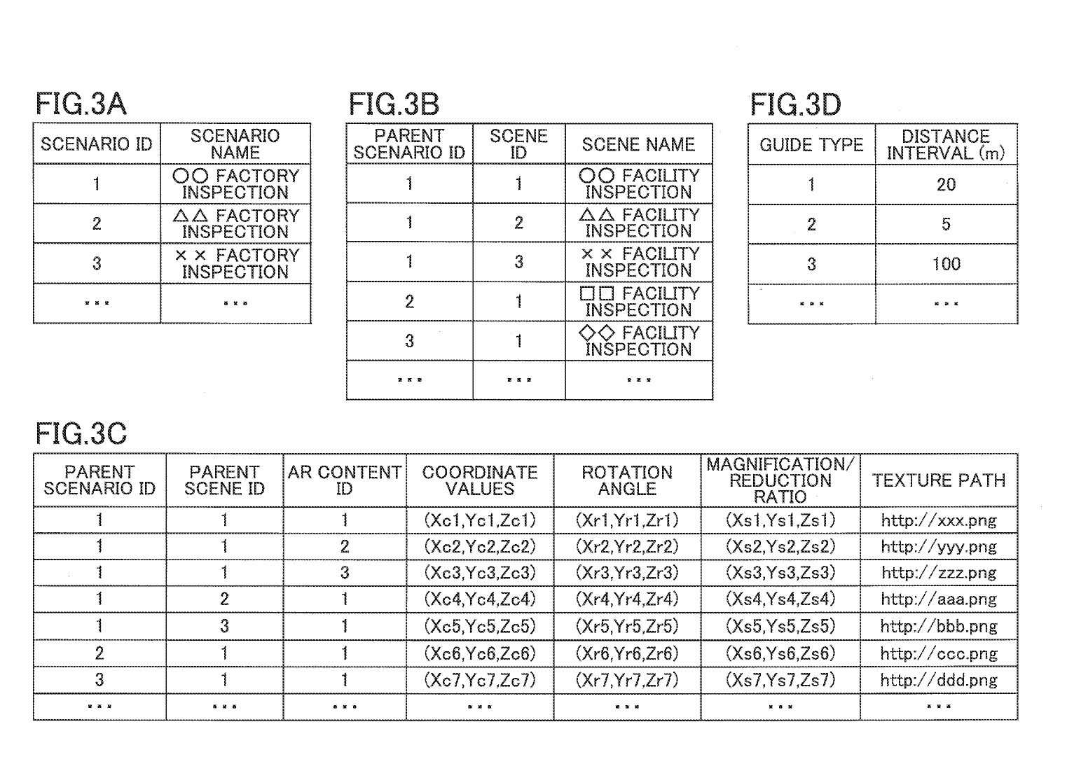

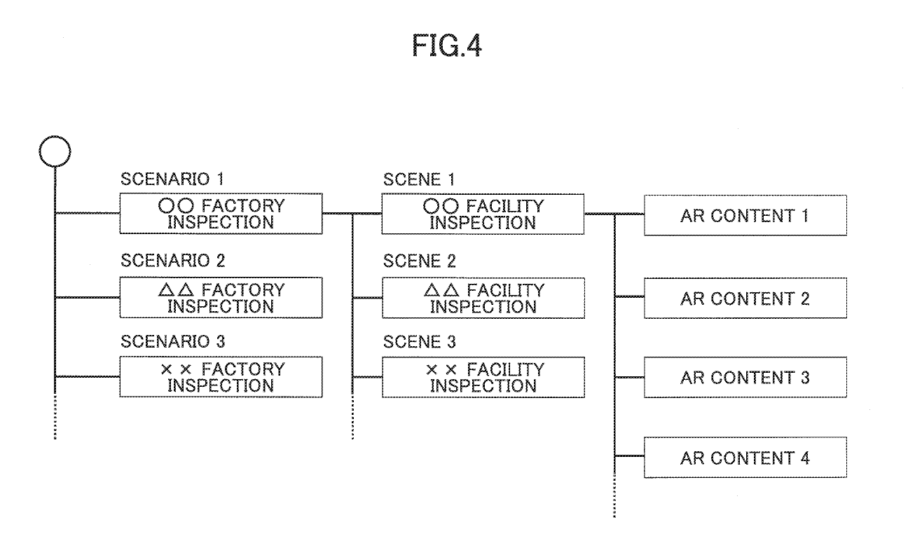

Next, examples of data used in the display process according to the present embodiment are described with reference to figures. FIGS. 3A through 3D illustrate examples of various kinds of data applied in the present embodiment. Furthermore, FIG. 4 illustrates an example of a data configuration of various kinds of data. FIG. 3A illustrates an example of a scenario management table, FIG. 3B illustrates an example of a scene management table, FIG. 3C illustrates an example of an AR content management table, and FIG. 3D illustrates an example of a guide display table.

For example, in the present embodiment, the object data may be set in association with the respective coordinate values (position information), to be indicated on a world coordinate system corresponding to position information (latitude, longitude, altitude) acquired from GPS. However, when multiple object data items are set with respect to a particular position or orientation of the terminal 10, it will not be possible to display all of the object data items at the time of the viewing mode. Furthermore, for example, in a case of inspection operations, etc., at a factory, etc., when precautions, operation contents, etc., are set in advance with the use of object data, the person in charge of the inspection is to acquire the information with respect to the target (scenario or scene) that the person is in charge of. Therefore, in the present embodiment, in the authoring process, the AR content information is separately set in hierarchies as illustrated in FIG. 4, based on the scenario and the scene such as the location, the environment, etc. Accordingly, the AR content information to be displayed at the time of the viewing mode may be selected.

Examples of items in the example of the scenario management table of FIG. 3A are “scenario ID”, “scenario name”, etc.; however, the items are not so limited. “Scenario ID” is information for identifying the scenario of the target to which the AR content information is to be provided. “Scenario name” is the name of the scenario corresponding to the scenario ID, and may be distinguished by, for example, a plan name, an operation name, the present contents, etc.; however, the scenario names are not so limited.

Examples of items in the example of the scene management table of FIG. 3B are “parent scenario ID”, “scene ID”, “scene name”, etc.; however, the items are not so limited. “Parent scenario ID” indicates the identification information of a scenario, and is associated with the item “scenario ID” in the scenario management table of FIG. 3A.

“Scene ID” is information for identifying a scene corresponding to the parent scenario, and is also information for segmenting the “scenario ID” into predetermined scenes. Furthermore, the “scene name” is information of the location, an event, operation contents, etc., corresponding to the scene ID; however, the scene names are not so limited.

Examples of items in the example of the AR content management table of FIG. 3C are “parent scenario ID”, “parent scene ID”, “AR content ID”, “coordinate values”, “rotation angle”, “magnification/reduction ratio”, “texture path”, etc.; however, the items are not so limited.

“Parent scenario ID” is associated with the scenario ID indicated in FIG. 3A. “Parent scene ID” is obtained by segmenting the parent scenario ID into predetermined scenes, and is associated with the scene ID in FIG. 3B. “AR content ID” is information for identifying one or more object data items corresponding to the respective parent scene IDs. “Coordinate values” is information relevant to a three-dimensional position (Xc1, Yc1, Zc1) at which the object data is displayed.

“Rotation angle” is information (Xr1, Yr1, Zr1) indicating how much the object data is tilted in the three-dimensional direction from a basic angle set in advance. “Magnification/reduction ratio” is information indicating the magnification ratio and the reduction ratio by using a predetermined size of the object data as a reference, and is set as (Xs1, Ys1, Zs1) with respect to the three-dimensional axis directions (X, Y, Z). In the present embodiment, at least one of the above-described “coordinate values”, “rotation angle”, and “magnification/reduction ratio” may be used as the position information of the object data.

“Texture path” is storage destination information of object data corresponding to the AR content ID. For example, the “texture path” may be address information such as “http://xxx.png” of a management server, a device other than a management server, etc., or the storage destination of a folder, etc.; however, the “texture path” is not so limited. Furthermore, in the “texture path”, information (file name) such as image data, video data, text data, etc., corresponding to the object data, may be directly stored.

In the present embodiment, each example of data illustrated in FIGS. 3A through 3C has a data configuration formed of hierarchies as illustrated in FIG. 4. In the example of FIG. 4, with respect to “◯◯ factory inspection” of scenario ID “1”, scenes of “◯◯ facility inspection” (scene 1), “ΔΔ facility inspection” (scene 2), and “×× facility inspection” (scene 3) are set as segments of the scenario. These scenes may be expressed in hierarchies, and furthermore, AR contents 1 through 4 are set in each scene. That is, in each scene, a plurality of AR content information items may be set. In the example of FIG. 4, the data is managed by an image of a tree structure; however, the structure, etc., by which the data is managed is not so limited.

Examples of items in the example of the guide management table of FIG. 3D are “guide type”, “distance interval (m)”, etc.; however, the items are not so limited. “Guide type” is information indicating the type of guides (information indicating the distance from the terminal 10) that are displayed on a screen at the time of performing authoring. In the present embodiment, object data (objects used as guides) for displaying the guides is set in advance for each guide type. “Distance interval” is information indicating the intervals from the terminal 10 at which the guides are to be displayed. The distance interval may be set for each guide type. For example, with respect to the distance interval of guide type “1”, the guides may be displayed at intervals of 20 m by setting the terminal 10 as the reference; however, the distance interval is not so limited. Examples of guides are flags, walls, circles, ovals, etc., and may be displayed in different colors for each interval; however, the guides are not so limited.

Note that the various kinds of data described above are information that is set at the terminal 10, or acquired from a management server, etc., via the above-described communication network, and stored in the storage unit 14, etc. The above information may be, for example, acquired from a management server, etc., when the display control process according to the present embodiment is executed; however, the display control process is not so limited. The terminal 10 may change and update the AR content information set in advance, and the contents of the data may also be changed and updated accordingly. Furthermore, the above information may be set in association with user information acquired from the terminal 10. Furthermore, the information stored in the storage unit 14 is not limited to the examples of data described above; user information, process history information, various kinds of setting information, etc., may be stored.

### <Example of Display Control Process>

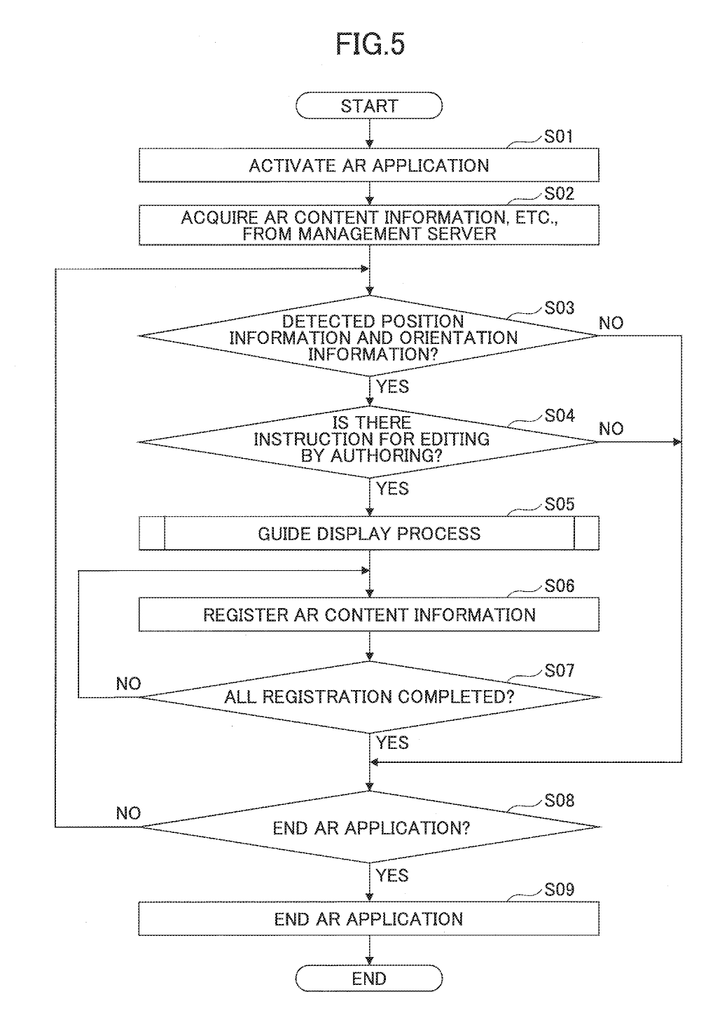

Next, an example of a display control process according to the present embodiment is described with reference to a flowchart. FIG. 5 is a flowchart of an example of a display control process according to the present embodiment. In the example of FIG. 5, the control unit 19 of the terminal 10 activates an AR application for performing the display control process according to the present embodiment (step S01), and acquires AR content information, etc., from a management server (step S02).

Note that in the process of step S01, by activating the AR application, for example, imaging by the imaging unit 12 may be started and a captured image may be acquired, or a captured image may be acquired from a device other than the imaging unit 12 and the acquired image may be displayed on a screen. Furthermore, when the terminal 10 is a display device, etc., such as a head mounted display, not only the captured image, but the real space ahead of the captured image will be visible via a transmission type screen (display unit). Furthermore, in the process of step S02, for example, the AR content information as indicated in FIGS. 3A through 3C may be acquired, or the AR content information does not have to be acquired. Furthermore, in the process of step S02, for example, a guide display table, etc., as illustrated in FIG. 3D may be acquired; however, when the guide display table is already stored in the storage unit 14, the guide display table does not have to be acquired.

Next, the detection unit 15 executes the detection of position information and orientation information of the terminal 10, and determines whether the position information and orientation information have been detected (step S03). In the process of step S03, for example, the position information may be positioned by using GPS, etc., and for example, the orientation information may be detected by using an electronic compass, etc.; however, the detection unit 15 is not so limited, as long as at least the position information is detected.

If the position information and the orientation information are detected (YES in step S03), the determining unit 17 determines whether an instruction for editing by authoring has been given by a user's operation (whether the present mode is for performing an authoring process) (step S04). The process of step S04 includes, for example, an editing instruction in a case of registering new AR content information by authoring, a case of changing the AR content information already registered, etc. Furthermore, the instruction for editing by authoring may be input by, for example, touching a screen corresponding to the instruction in advance, or inputting operations, a voice sound in the terminal 10, etc.; however, the editing by authoring is not so limited.

In the process of step S04, if an instruction for editing by authoring is given (YES in step S04), the display control unit 18 performs a guide display process according to the present embodiment (step S05). The process of step S05 is described below.

Next, the data processing unit 16 performs a process of registering the AR content information (step S06). In the process of step S06, the type, the size, the rotation angle, the display position, etc., of the object data are registered with respect an area specified according to the position and the orientation of the terminal 10, for each scenario and scene as indicated in FIGS. 3A through 3C described above.

Next, the data processing unit 16 determines whether registration of all information has been completed (step S07), and if registration of all information is not completed (NO in step S07), the process returns to step S06. Furthermore, if registration of all information has been completed (YES in step S07), or if the position information and the orientation information are not detected in the process of step S03 (NO in step S03), the data processing unit 16 determines whether to end the AR application (step S08).

If the AR application is not to be ended (NO in step S08), the process returns to step S03. Furthermore, if the AR application is to be ended (YES in step S08), the AR application is ended (step S09), and the display control process in authoring is ended.

After the AR content information, etc., has been set by the above authoring process, the terminal 10 performs a process of the viewing mode. For example, in the process of the viewing mode, object data included in AR content information is displayed at a predetermined position in the screen of the display unit 13, when AR content information, which is registered in association with a position in an area specified according to the position and orientation of the terminal 10, is detected.

### <Step S05; Guide Display Process>

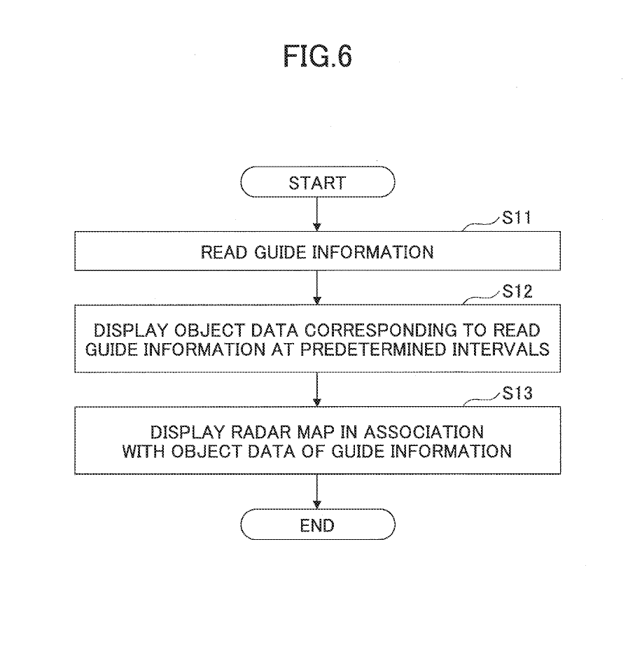

Next, a guide display process described above (step S05), is described with reference to a flowchart. FIG. 6 is a flowchart of an example of a guide display process. In the example of FIG. 6, the display control unit 18 reads the guide information stored in the storage unit 14 in advance (step S11), and displays the object data (objects used as guides) corresponding to the guide information that is read, at predetermined intervals (step S12). Here, the guide information is, for example, the guide management table, etc., illustrated in FIG. 3D, and includes, for example, objects used as guides managed by the AR application, etc., the display distance interval of the objects used as guides, etc.; however, the guide information is not so limited.

Furthermore, in the process of step S12, the user may set or select the objects used as guides to be displayed at the discretion of the user, by a setting screen, etc., displayed on the terminal 10. The guides are displayed based on the distance interval from the terminal 10, set for each guide type.

Next, the display control unit 18 displays a radar map indicating the position information of the objects used as guides (step S13). Here, in the radar map, the position information of the AR content information around the terminal 10 set by the authoring process, is displayed as a map. Note that in the present embodiment, the process of displaying a radar map of step S13 does not have to be performed; the user may set whether to display or not display the radar map, at the discretion of the user.

### <Examples of Screens>

Next, examples of screens to which the present embodiment is applied, are described with reference to figures. In the following examples, a tablet terminal is indicated as an example of the terminal 10; however, the terminal 10 is not so limited; for example, a display device such as a head mounted display may be used.

### FIRST EXAMPLE

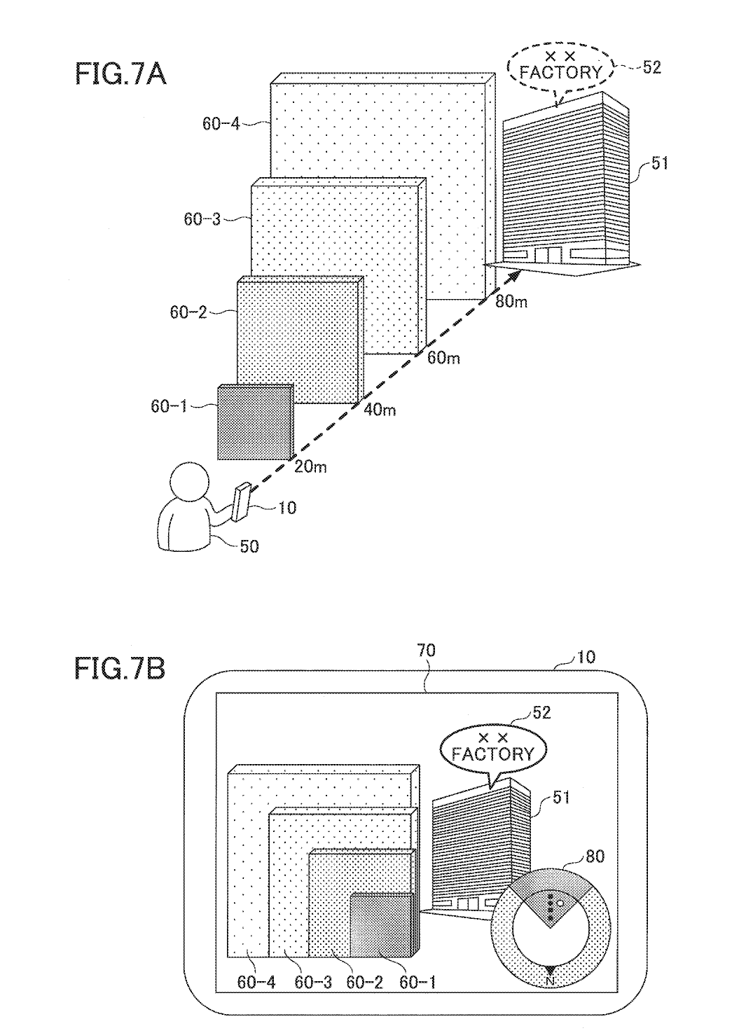

FIGS. 7A and 7B illustrate a first example of displaying guides according to the present embodiment. FIG. 7A is a conceptual diagram of displaying guides of the first example, and FIG. 7B illustrates an example of a screen displaying guides of the first example

For example, the first example illustrated in FIGS. 7A and 7B indicates a case where a user 50 performs an authoring process by setting AR content information 52 with respect to a real object 51 (for example, a building, a mountain, etc.) that is located at a predetermined distance from the terminal 10.

In the first example, first, the terminal 10 receives an instruction or an operation to indicate that an authoring process is to be performed. Subsequently, as illustrated in FIG. 7A, the terminal 10 displays objects used as guides 60-1 through 60-4 set in advance at predetermined intervals (for example, at intervals of 20 m), by using the position of the terminal 10 as a reference (0 m), in a screen 70 of the terminal 10.

The objects used as guides 60-1 through 60-4 are display objects having transmittance. Therefore, the scenery, the real object, etc., ahead of the objects used as guides 60-1 through 60-4 are displayed on the screen 70 without being hidden. Furthermore, the objects used as guides 60-1 through 60-4 are displayed at intervals corresponding to the guide type; however, the intervals are not so limited. Furthermore, the number of displayed objects used as guides 60 is not limited to four; a predetermined number of objects used as guides may be displayed, or one or more objects used as guides may be displayed up to a predetermined distance from the terminal 10.

Note that as illustrated in FIGS. 7A and 7B, the objects used as guides 60-1 through 60-4 may be displayed differently in terms of at least one of the color, the shape, the size, etc., such that the objects used as guides 60-1 through 60-4 are distinguished from each other. Furthermore, when the size differs, the displayed size of the objects used as guides preferably increases as the distance away from the terminal 10 increases. Accordingly, as illustrated in FIGS. 7B, even when the displayed objects used as guides 60-1 through 60-4 are superimposed on each other in the screen 70 of the terminal 10, the object used for the guide at the back is visible and not entirely hidden.

Furthermore, in the present embodiment, the display control unit 18 may also display a radar map 80 indicating the position information of the objects used as guides 60, as illustrated in FIG. 7B, in addition to displaying the objects used as guides 60 described above.

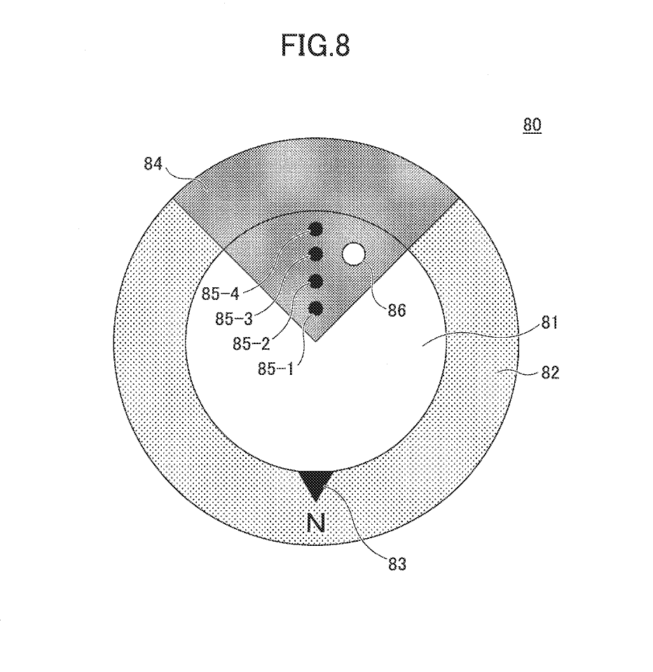

FIG. 8 illustrates an example of a screen of the radar map. An example of a radar map 80 illustrated in FIG. 8 includes an AR content information display area 81, an AR content information non-display area 82, azimuth direction information 83, an eyesight area 84, position information of objects used as guides 85-1 through 85-4, and object data position information 86, with respect to the entire display range (may be set at 50 m through 200000 m).

The AR content information display area 81 displays the object data position information 86 for an object that is present within a predetermined distance (for example, a radius of 100 m, a radius of 1 km, etc.), in the surrounding 360° centering around the position information of the terminal 10. For example, when the object data position information 86 is present within the AR content information display area 81 and also within the eyesight area 84, the corresponding object data is displayed on the screen.

The AR content information non-display area 82 displays the object data position information 86 that is further away than the AR content information display area 81 and present within a predetermined distance (for example, a radius of 200 m, a radius of 2 km, etc.), in the surrounding 360° centering around the position information of the terminal 10. For example, even if the object data position information 86 is present within the eyesight area 84, if the object data position information 86 is present within the AR content information non-display area 82, the corresponding object data is not displayed on the screen.

The azimuth direction information 83 is information of a predetermined azimuth direction (for example, “north”, etc.), which is used as a reference for confirming the direction of the eyesight range of the terminal 10. The eyesight area 84 is an area specified according to the position and the orientation of the terminal 10, and corresponds to, for example, the display contents in the screen 70. For example, the range of the eyesight area 84 may be changed according to the imaging range (angular field information) of the imaging unit 12, the distance that may be detected, etc.

The position information of objects used as guides 85-1 through 85-4 is information indicating the respective positions of the objects used as guides 60-1 through 60-4 described above. Note that in the example of FIG. 8, the intervals between the position information of objects used as guides 85-1 through 85-4 may be displayed.

The object data position information 86 is position information of the AR content information (object information) that has undergone the authoring process. For example, the object data position information 86 corresponds to the AR content information 52 illustrated in FIG. 7B.

The respective display contents in the radar map 80 are not limited to the example of FIG. 8; the color, the design, etc., may be changed to any other color, design, etc. Furthermore, the object data position information 86 may display the AR content information already registered and the AR content information presently being edited, in different colors, designs, etc.

Furthermore, the display mode of the position information according to the present embodiment is not limited to that of the radar map 80; for example, a rectangular map, etc., may be displayed. Furthermore, the radar map 80 is not limited to a two-dimensional map; the radar map 80 may be a three-dimensional spherical (or cubic) map. Furthermore, the display position of the radar map 80 is not limited to the bottom right of the screen 70 as in FIG. 7B, and the display and non-display of the radar map 80 may be switched by user operations.

Note that in the example of FIGS. 7A and 7B, the position coordinates of the object data of the AR content information 52 are determined by the latitude (degrees), the longitude (degrees), and the altitude (m), etc. Furthermore, the radar map 80 in the example of FIG. 8 expresses 0.00001 (degrees) to be approximated to 1 (m); however, the radar map 80 is not so limited.

In the first example, as illustrated in FIG. 7B, displayed guides such as the objects used as guides 60, the radar map 80, etc., are displayed on the screen, and therefore when setting the position of the AR content information 52 with respect to the real object 51 (real object included within the eyesight range) in the screen 70, the position of the AR content information 52 to be set and the position of the AR content information 52 being edited may be relatively compared with the guides. Accordingly, in the authoring process, it is possible to appropriately input the position, particularly in the depth direction, in which the position information acquired by GPS, etc., has a large error. Note that in the present embodiment, for example, when inputting the position of the object data in the horizontal direction and in the vertical direction in the authoring process, objects used as guides 60 for supporting the input process may be displayed.

By inputting the position of the object data according to the first example, it is possible to display the object data included in the AR content information 52 at an appropriate position in the viewing mode after the authoring process.

### SECOND EXAMPLE

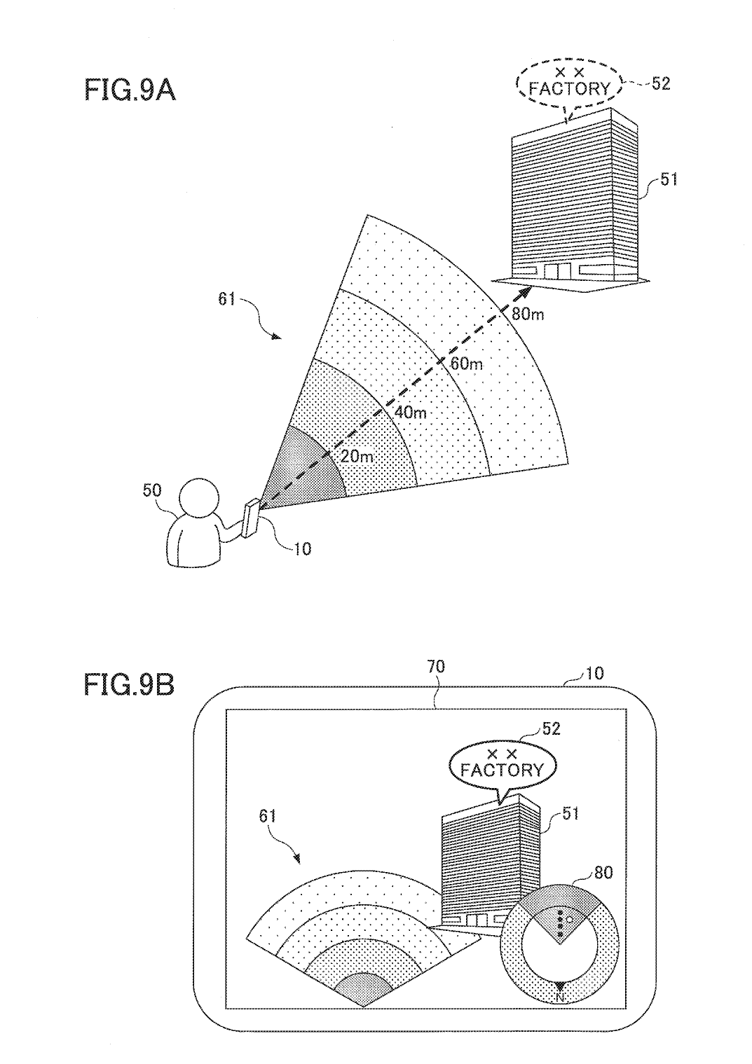

FIGS. 9A and 9B illustrate a second example of displaying guides according to the present embodiment. FIG. 9A is a conceptual diagram of displaying guides of the second example, and FIG. 9B illustrates an example of a screen displaying guides of the second example.

For example, the second example illustrated in FIGS. 9A and 9B indicates a case in which when a user 50 sets the AR content information 52 with respect to the real object 51 at a predetermined distance from the terminal 10, an object used as guides 61 is displayed in a sector form along the ground as illustrated in FIG. 9A. Note that in the second example, different colors and different designs are applied to the object used as guides 61 according to the distance from the terminal 10, and the object used as guides 61 is displayed in a transmissive manner; however, the object used as guides is not so limited. Furthermore, the shape of the object used as guides 61 is not limited to a sector; for example, the object used as guides 61 may be a circle, a half circle, an oval, etc. Accordingly, as illustrated in FIG. 9B, it is possible to set the AR content information 52 at an appropriate position (the position in the depth direction, etc.) in the screen 70 of the terminal 10, by using the object used as guides 61 as a reference.

### THIRD EXAMPLE

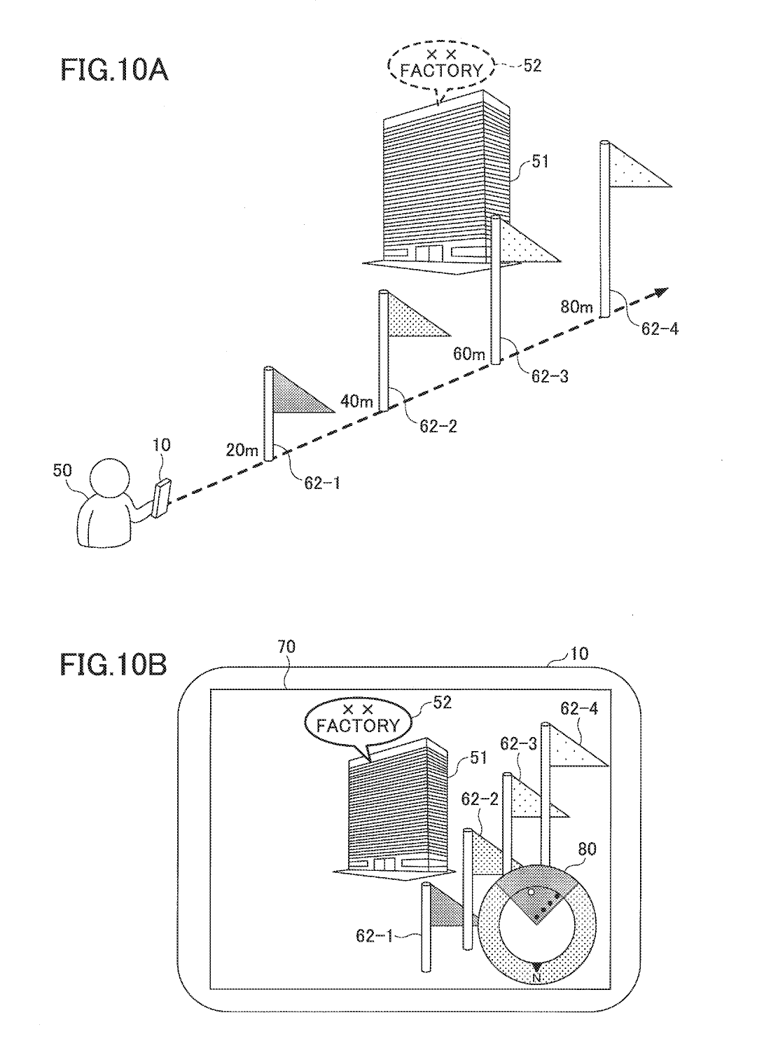

FIGS. 10A and 10B illustrate a third example of displaying guides according to the present embodiment. FIG. 10A is a conceptual diagram of displaying guides of the third example, and FIG. 10B illustrates an example of a screen displaying guides of the third example.

For example, the third example illustrated in FIGS. 10A and 10B indicates a case in which objects used as guides 62-1 through 62-4, which are flags, are diagonally displayed with respect to the screen 70 of the terminal 10. For example, when a user 50 sets AR content information 52 (performs an authoring process) with respect to a real object 51 that is located at a predetermined distance from the terminal 10, the display control unit 18 diagonally displays the objects used as guides 62-1 through 62-4 in a transmissive manner in the screen 70, as illustrated in FIG. 10A.

Note that the tilt of the diagonal direction may be, for example, set by the user in advance as setting information. For example, the display control unit 18 acquires the objects used as guides 62 corresponding to the guide type that is set, and displays the objects used as guides 62 at predetermined intervals at positions along a diagonal direction having a tilt angle acquired from the setting information, instead of the front direction obtained from the orientation information of the terminal 10. Furthermore, when the display control unit 18 displays position information of objects used as guides in the radar map 80, the display control unit 18 displays this information in a diagonal direction tilted by a predetermined angle, instead of the front direction, in accordance with the display positions of the objects used as guides 62

By the third example, as illustrated in FIG. 10B, the objects used as guides 62-1 through 62-4 may be displayed on the screen 70 without overlapping each other, and therefore the guide positions may be easily recognized.

### FOURTH EXAMPLE

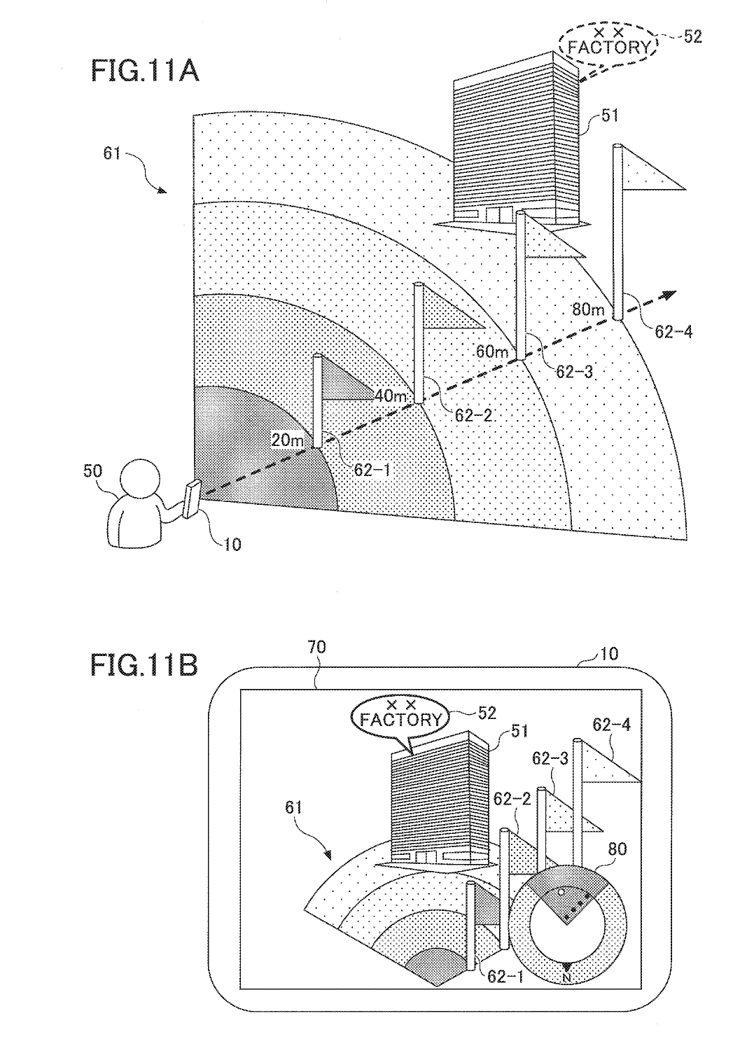

FIGS. 11A and 11B illustrate a fourth example of displaying guides according to the present embodiment. FIG. 11A is a conceptual diagram of displaying guides of the fourth example, and FIG. 11B illustrates an example of a screen displaying guides of the fourth example.

In the fourth example, as illustrated in FIGS. 11A and 11B, a plurality of objects used as guides are displayed. Accordingly, the distance to the real object 51 (information of depth direction) included within the eyesight range is recognized more easily. Note that in the example of FIG. 11B, the objects used as guides are displayed at a diagonally forward position of the screen 70, and objects used as guides 62 that are flags, and the object used as guides 61 that has a sector form, are displayed in combination; however, the type of guides to be displayed are not so limited.

Furthermore, in the fourth example, the intervals may be varied according to the type of guide, or both types of guides may be displayed on the screen 70 at one of the distance intervals set for the respective types of guides (for example, the shorter intervals).

Note that the display control unit 18 described above may be able to set “whether to display guides”, “type of guides”, “distance intervals”, etc., relating to the display of the guides described above, by using an option screen, etc., of the terminal 10. Accordingly, whether the editing distance of the AR content information is short or long, the displaying of the guides may be changed appropriately.

As described above, according to the present embodiment, when inputting the position information of the object data in the mode of the authoring process, the input of the position in the depth direction may be supported by displaying guides, etc. Note that the guides described above may be set to be displayed not only in the mode of the authoring process but also in the viewing mode.

According to an aspect of the embodiments, it is possible to support the operation of inputting the position in the depth direction, when inputting the position information of the object data.

The present invention is not limited to the specific embodiments described herein, and variations and modifications may be made without departing from the scope of the present invention. Furthermore, all of or some of the elements in the above embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control method executed by a computer, the display control method comprising:
determining, when object data is detected, whether a present mode is a mode for receiving input of position information with which the object data is to be associated, the object data being registered in association with a position in an area that is specified according to a terminal position and an orientation of a terminal; and
displaying, on a display unit, a distance information item indicating a distance from the terminal when the present mode is the mode for receiving the position information with which the object data is to be associated, wherein the object data is displayed on the display unit by using the distance information item.

2. The display control method according to claim 1, wherein
the displaying includes displaying the distance information item on the display unit that is a transmission type display that is arranged within eyesight of a user of the terminal, wherein the distance information item is displayed on the display unit as a display object having transmittivity.

3. The display control method according to claim 1, wherein
the displaying includes displaying the distance information item that is predetermined object data set in advance.

4. The display control method according to claim 1, wherein
the displaying includes displaying the distance information item at distance intervals according a type of the distance information item.

5. The display control method according to claim 1, wherein
the displaying includes displaying a plurality of the distance information items according to the distance from the terminal, wherein the plurality of the distance information items are displayed differently in terms of at least one of color, shape, and size.

6. The display control method according to claim 1, wherein
the displaying includes displaying position information with respect to the distance information item, on a radar map.

7. A non-transitory computer-readable recording medium storing a display control program that causes a computer to execute a process, the process comprising:
determining, when object data is detected, whether a present mode is a mode for receiving input of position information with which the object data is to be associated, the object data being registered in association with a position in an area that is specified according to a terminal position and an orientation of a terminal; and
displaying, on a display unit, a distance information item indicating a distance from the terminal when the present mode is the mode for receiving the position information with which the object data is to be associated, wherein the object data is displayed on the display unit by using the distance information item.

8. An information processing apparatus comprising:
a processor configured to execute a process including
determining, when object data is detected, whether a present mode is a mode for receiving input of position information with which the object data is to be associated, the object data being registered in association with a position in an area that is specified according to a position and an orientation that are detected; and
displaying, on a display unit, a distance information item indicating a distance from the information processing apparatus when the present mode is the mode for receiving the position information with which the object data is to be associated, wherein the object data is displayed on the display unit by using the distance information item.
